(19) United States
(12) Patent Application Publication
(10) Pub. No.: US 2007/0072591 A1
(43) Pub. Date: Mar. 29, 2007

(54) Enhanced directory assistance system and method including location search functions

(76) Inventors: Faith McGary, Bethlehem, PA (US); Ian Bacon, Manassas, VA (US)

Correspondence Address: SOFER & HAROUN LLP., 317 MADISON AVENUE, SUITE 910, NEW YORK, NY, 10017, US

(21) Appl. No.: 11/526,837

(22) Filed: Sep. 25, 2006

Related U.S. Application Data
(60) Provisional application No. 60/719,941, filed on Sep. 23, 2005.
(60) Provisional application No. 60/756,606, filed on Jan. 4, 2006.

(51) Int. Cl. H04Q 7/38

(52) U.S. Cl. 455/414.1

(57) ABSTRACT

A method for sending a targeted advertising campaign to a plurality of mobile phone devices, comprises the step of receiving geographic information relating to geographic location of mobile phone devices, wherein the information is collected from a plurality of corresponding mobile service providers. The method includes the step of maintaining a subscriber database that contains contact information relating to a plurality of subscribers. The system interacts with an advertiser so as to receive advertising content intended for targeted mobile phone devices. Furthermore, the system communicates the advertising content to the targeted mobile phone devices that are located within a specified distance from a location specified by the advertiser.

### RELATED APPLICATIONS

This Application claims priority to provisional application 60/719,941 filed Sep. 23, 2005, and provisional application 60/756,606 filed Jan. 4, 2006, both of which are incorporated herein by reference.

### FIELD OF THE INVENTION

This invention relates to directory assistance system and more specifically to a system and method for locating a plurality of mobile phone devices that are serviced by a plurality of corresponding mobile service providers.

### BACKGROUND OF THE INVENTION

Due to the rapid progress in the wired and wireless communication, more and more data access systems are developed in order to provide users of mobile devices access to a wide range and large amount of applications and data. These systems aim to provide users with a seamless easy access to various applications and data on a subscription basis. For example, in portable wireless devices, users want to be able to bring along their data with them or have access to their data wherever they go.

However, when the number of the users accessing to the system is large, the performance would become inhibitively slow. A data-hosting server is an application server for this purpose. It provides hosting services for information such as text message, picture messages, maps, directions, emails, phonebook records, uploaded image and audio files, stock portfolios. These services allow the user to request a pre-defined amount of location-based data nearest to their current location. GPS services can also be used to locate other users nearest to their geographic location via cellular triangulation services. For example, services may be used to locate the nearest fast-food restaurants, nearest movie theaters or other such amenities that are in close proximity to the caller.

Despite some progress recently made in this area of technology, there is a need for location based directory services that allow users enhanced connectivity at affordable pricing schemes.

### OBJECTS AND SUMMARY

The present invention is directed to a data hosting service that allows the user to access data without being aware of the whereabouts of the data location, and regardless of data types. The data-hosting server provides a mechanism that, from the user's point of view, the hosting server hosts all data. However, this does not mean that the data is solely stored at the hosting server. Instead, the data could be scattered across servers at different geographic locations, or on other application servers at different locations around the world. The user only sees the data in one location, but the data may, in fact, be stored in multiple locations

It is another object of the present invention to improve on the location services functionality and provide a system and method that includes a set of computer programs that reside on a remote computing environment, called the platform server, and a client program that resides on a portable wired or wireless device, called the platform client. When a user accesses data, the platform client determines if the data is already on the client device. If it is, it loads the data. If the application is not on the client device, the platform client retrieves the data from the platform server or in a manual process with a live directory assistance operator. During this data accessing step, regardless of whether the data is retrieved from the client device or the platform server, the user is unaware of the location where the data is being retrieved from.

The present invention further provides a virtual data hosting server associated with the platform server that employs scalable and distributed technologies to provide a mechanism to users in which all of the data is hosted by the data hosting server. This virtual data hosting server allows requested data from a user, either through voice, SMS/MMS, Instant Messaging, GPS, or Common Short Codes, to be delivered to a wireless device or landline client device. Here when a user access the platform server the data hosting server provides results to the client device that are stored thereon. But in the case where there is insufficient data on the data hosting server to meet the request criteria, the virtual data hosting server is able to seamlessly supplement the search results so that final result is a complete reply to the user (client device) including data from the data hosting server as well as data obtained through a search of additional remotely located data hosting servers.

It is understood that the invention is not limited in this capacity. For example, the request can be given by the user for a limited number or a subscribed to number of locations within an identified location. Types of requested data returned to the user by directory assistance include: Text, SMS, MMS, GPS, Common Short Code data, maps, directions, business data, social data, geographic data, historical data, government data, tourist data, and/or emergency services.

In accordance with one embodiment of the invention, a method for sending a targeted advertising campaign to a plurality of mobile phone devices is provided. The method comprises the steps of receiving geographic information of mobile phone devices, wherein the information is collected from a plurality of corresponding mobile service providers. The method also comprises the step of maintaining a subscriber database that contains contact information relating to a plurality of subscribers. The system interacts with an advertiser so as to receive advertising content intended for targeted mobile phone devices. The system communicates the advertising content to targeted mobile phone devices that are located within a specified distance from a location specified by the advertiser.

In accordance with another embodiment of the invention, a method for providing location information of a plurality of mobile devices is provided. The method includes the steps of receiving geographic information relating to geographic location of the mobile phone devices, wherein the information is collected from a plurality of corresponding mobile service providers. The system in accordance with this method receives a request from a subscriber mobile device to track a geographic location of another mobile device as identified by the subscriber. The system then retrieves the geographic information of the desired mobile device. Thereafter the system communicates the geographic location of the desired mobile device to the subscriber mobile device.

### BRIEF DESCRIPTION OF THE DRAWINGS

FIG. 1 illustrates a network arrangement for a directory assistance system in accordance with one embodiment of the present invention.

FIG. 2 illustrates a block diagram of a directory assistance system in accordance with one embodiment of the invention.

FIG. 3 illustrates a block diagram of a client platform in a mobile device in accordance with one embodiment of the invention.

FIG. 4 is a data field for maintaining a list of locations of a desired set of mobile devices in accordance with one embodiment of the invention.

FIG. 5 is a data field for maintaining a list of subscribers and their geographic location in a directory assistance system in accordance with one embodiment of the present invention.

FIG. 6 is a flow chart illustrating the steps for providing an advertising content to a plurality of mobile devices located within a predefined distance from a desired location.

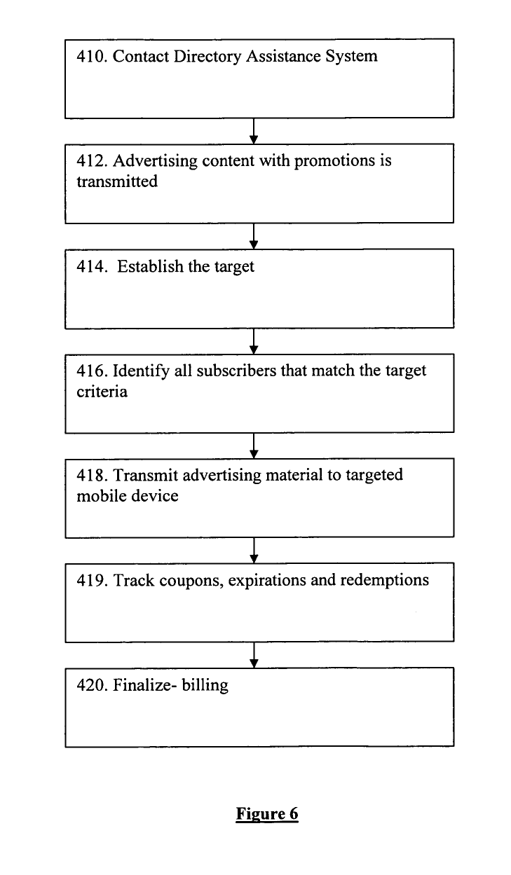

FIG. 7 is a flow chart illustrating the steps for setting up groups of mobile devices so as to track their location in accordance with one embodiment of the invention.

### DETAILED DESCRIPTION

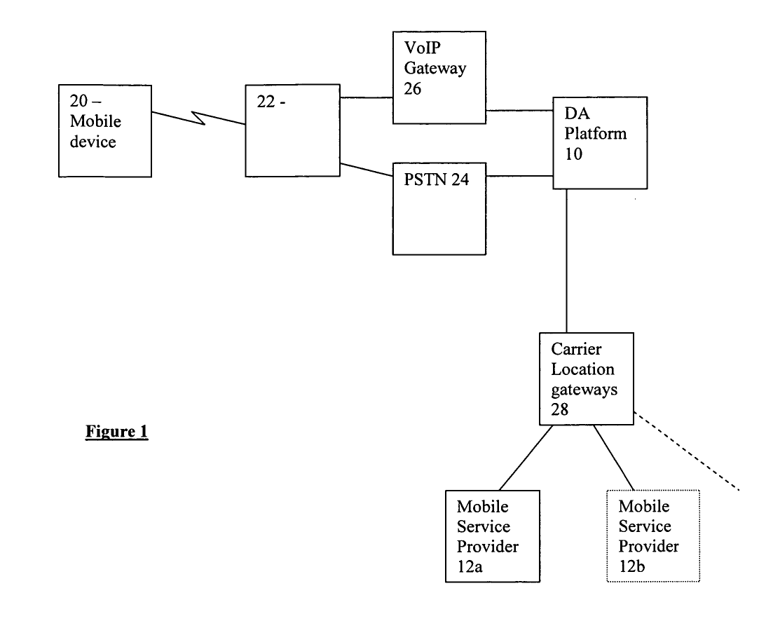

As illustrated in FIG. 1, an enhanced directory assistance system 10 is shown for use by a requester 20. As shown, requester 20 connects with enhanced directory assistance system 10 via connectivity element 22 to request a listing with a desired category of goods or services, preferably based on the location of the requester. Once the call enters system 10, the communication is handled by directory assistance platform 30 (hereinafter DA platform 30). DA platform 30 obtains the desired listings from a listing database and sends the listing to DA platform 30 to complete the call with requester 20.

In the present description, requester 20 is described as a user having a standard cell phone in order to demonstrate the salient features of the present invention. However, it is understood that requester 20 may include but is not limited to a user employing a VoIP phone, personal computer, PDA (Personal Digital Assistant), landline phone or any other personal communication device.

A connectivity element 22 is disposed between requester 20 and system 10 in order to facilitate communications between the two, capable of handling communications between system 10 and requester 20, via for example the traditional Public Switched Telephone Network (PSTN) 24 and VOIP gateway 26.

Although FIG. 1 illustrates only a single enhanced directory assistance system 10, it is understood that a number of systems 10 may be interconnected with one another over widely spaced geographic locations for handling requests at all times of the day, for handling request overflow, and for backup redundancy.

Directory Assistance system 10 is coupled to a carrier locations gateway 28, which acts as a clearing house for receiving location information from a variety of mobile service providers, such as mobile service provider 12a, mobile service provider 12b and so forth. Thus, in accordance with one embodiment of the invention, each mobile service provider gathers and sends to carrier location gateway 28, the location information of its corresponding subscribers who are registered with directory assistance system 10 as will be described in more detail below in accordance with various embodiments of the invention.

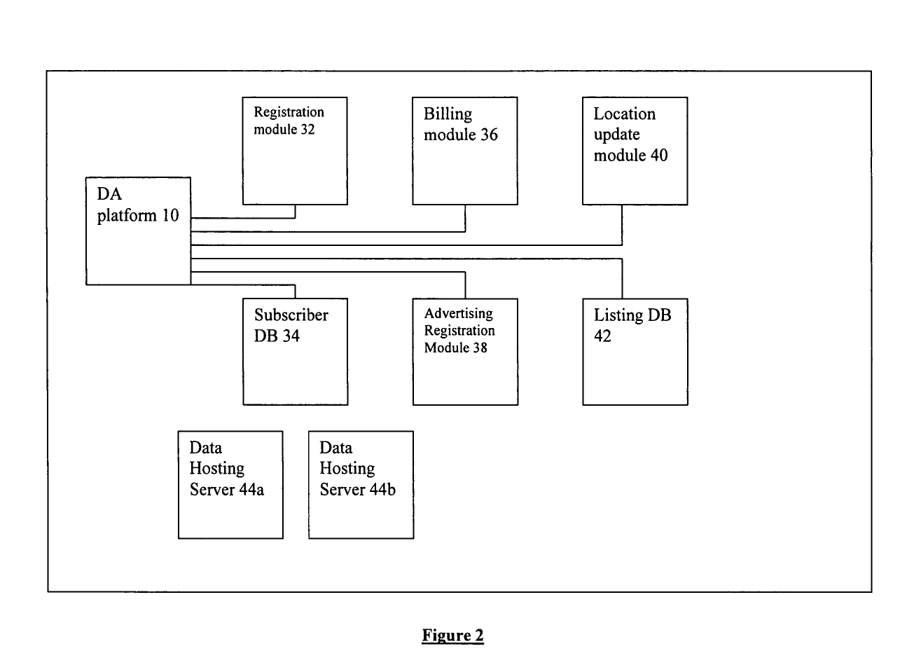

As illustrated in FIG. 2, in accordance with one embodiment of the invention, enhanced directory assistance system 10 maintains a directory assistance platform 30. DA platform 30 is configured to be the primary component for receiving and processing incoming requests from requester 20. It is understood that DA platform 30 may be comprised of a single component or more commonly comprised of a series of interlinked switches, ACD (Automatic Call Distribution) modules, operator terminals and other connectivity equipment. Furthermore, it is understood that DA platform 30 may employ live operators at operator terminals, completely automated response platforms, or a combination of the two for handling all of the features disclosed herein.

In addition to adding automated response options to DA platform 30, system 10 may also employ voice or speech recognition of requester 20. In this instance, DA platform 30 offers a series of automated options to select from, and requester 20 may respond verbally.

Returning to FIG. 2, DA platform 30 within system 10 is connected to a listing database 42. Listing database 42 is configured to store the necessary data to handle standard requests from requester 20, such as requests for telephone numbers or other such connectivity information such as physical addresses, e-mail addresses, web-listings etc . . .

Directory assistance platform 30 is also coupled to a location update module 40. The location update module in accordance with one embodiment of the invention is configured to gather updated location information of each subscriber to the system who has authorized the use of their location in accordance with various features of the invention as described in more detail below. Location update module 40 receives such updated location information from carrier location gateway 28 as described in reference with FIG. 1. As will be described in more detail below in accordance with various embodiments of the invention, the location information of each subscriber includes the geographical location along with the azimuth information, so as to provide the floor location information of a user who is located in a multi-storey building.

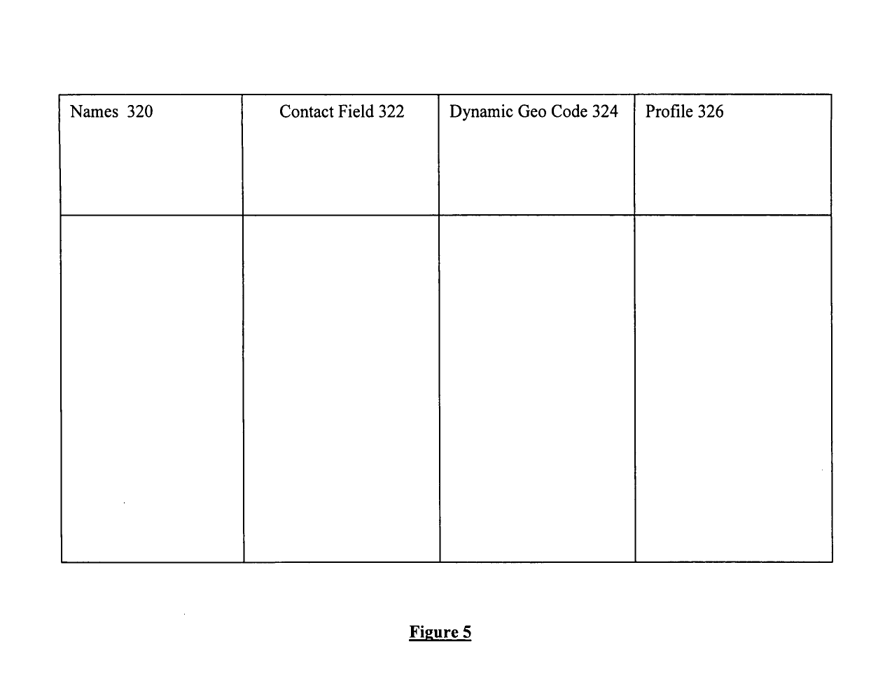

DA platform 30 is also coupled to a subscriber database 34. Subscriber database 34 contains information relating to all mobile device subscribers who have registered with directory assistance system 10. These registered subscribers in accordance with various embodiments of the invention allow system 10 to employ their updated location information. Subscribers who register with system 10 may encounter more features than subscribers who are listed based on traditional directory assistance services. Some types of information stored in subscriber database 34 as illustrated in FIG. 5, include names field 320, contact information field 322, dynamic location field 324 and profile field 326.

Profile field 326 includes a variety of personal information, such as demographics and subscriber's preferences for various goods and services. This profile information, in accordance with various embodiments of the invention is gathered via various means, such as subscribers interaction with a web site, or via their own mobile devices, or via contact to a service representative located at the directory assistance platform.

Directory assistance platform 30 is also coupled to a registration module 32. Registration module 32 is configured to handle the process for registering with the system to become a registered subscriber. This process includes various steps including the step of receiving requests from an already registered subscriber who desires to add other mobile device owners as subscribers to the system. The process includes other steps such as sending prompts to potential subscribers informing them that a registered subscriber has invited them to join a group (buddy) list.

In accordance with one embodiment, mobile device owners may be enticed to subscribe in return for free 411 services. As such a subscriber may even agree to receive targeted advertising messages in order to receive enhanced directory assistance services.

In accordance with other embodiments of the invention, the system is also configured so that a subscriber to the system is able to add a desired group of other mobile device owners to the subscriber's group (buddy) list without a registration process, such that their location is available upon request by the subscriber. However, this mode of operation of the system may raise privacy concerns.

Directory platform 30 is also coupled to an advertising registration module 38. Module 38 is configured to provide an interface with various goods and service providers whose listings are traditionally available to the directory assistance systems. In accordance with one embodiment of the invention, advertising registration module 38 allows the goods and service providers to launch targeted advertising to those mobile devices that travel within a predefined distance from the location of the goods or services. As such, module 38 administers the advertising process, including the process for defining a target audience, inputting the advertising content for broadcasting to the target audience, tracking promotions, such as discount coupons that can be transmitted to the targeted mobile devices, and tracking promotion usage to assess the success of the advertising campaign.

DA platform 30 is also coupled to a billing module 36 that is responsible for tracking various billing issues. In accordance with one embodiment of the invention, billing module 36 tracks and processes various fee arrangements for accessing and retrieving location information of mobile devices that are subscribed to their corresponding mobile service providers.

As described previously in connection with FIG. 1, it may be necessary to provide some sort of incentive to mobile service providers to access the geographic locations of their mobile device subscribers. In order for the current system in accordance with various embodiments of the invention, to be more efficiently operational, it is beneficial to gain access to geographic locations of as many mobile devices as possible, regardless of the carrier service providers they are subscribed with. As such, billing module 36 is configured to track the financial arrangements that have been agreed upon in order to access the geographic locations of the mobile devices. Some examples of the financial arrangements include access for a flat fee, or fee per usage.

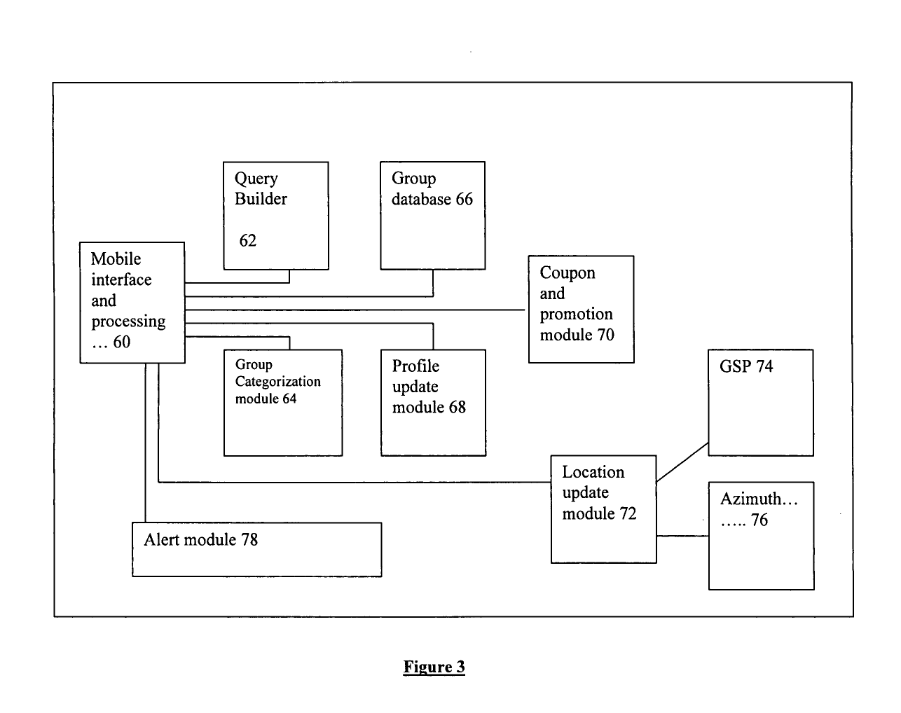

FIG. 3 illustrates a client platform 50 that is installed in a portable wired or wireless device, such as 20 illustrated in FIG. 1. As explained before, the portable device may be any one of a cellular phone, smart phone, VOIP device, laptop computer or any other user device capable of communicating with other devices. It is noted that although one embodiment of the invention is described in reference with FIG. 3, the invention is not limited in scope with the arrangement described in FIG. 3, and the system is capable of operating without the features disclosed in this Figure.

Client platform 50 includes a mobile interface and processing module 60, which preferably includes the operating system installed in mobile device 20 in charge of control and operation of the device. Mobile interface and processing module 60 is coupled to various modules, including a location update module 72. Location update module 72 is configured to gather the geographic location of mobile device 20. To this end, location update module 72 is coupled to a GPS module 74 for obtaining longitude, latitude information of device 20. Location update module 72 is also coupled to an azimuth/attitude detecting sensor 76 that is capable to provide the height information of device 20.

An example of an azimuth sensor is described in detail in U.S. publication number US2006/0038718 published on Feb. 23, 2006 and is incorporated herein by reference. Another example of a height sensor is described in detail in U.S. Pat. No. 6,122,960 entitled System and Method For Measuring Movement of Objects, issued on Sep. 26, 2000.

In accordance with one embodiment of the invention, location update manager 72 and/or location update module 40 are configured to determine the location of a mobile device within a city territory, and also whether the mobile device is located inside a building and if so the floor in which it's located if the building is a multi-story building. To this end, location update module 72, in accordance with one embodiment of the invention, provides the mobile device with the same functionality as those available on commercial navigation devices, such as those provided by Garmin.

Location update module provides the location information to carrier location gateway 28, via its corresponding mobile service provider 12. This information is gathered by location update module 40 of directory assistance system 10, so as to dynamically update subscriber database 34.

Mobile Interface and processing module 60 is also coupled to a group categorization module 64. Group categorization module 64 allows the mobile device subscriber to set up various group (buddy) lists so as to request an updated location of the individual members of each group. In accordance with one embodiment of the invention, group categorization module 64 interacts with the contact listing stored in the mobile device, allowing the subscriber to scroll through the contacts and select individual listings to define a desired group. Group categorization module 64 also interacts with the subscriber to assign group categories and sub categories to each listing.

Group categorization module 64 also interacts with the subscriber to assign alerts for each listing, so that when an individual within the group is within a predefined distance from the mobile device an alert signal is generated to allow the mobile device subscriber to be notified that one or more members of the group are within their vicinity. To this end, location update module is configured to display the location of each member of the group on a map so as to allow the subscriber to visually perceive the locations. By scrolling from one group category to other, individual members of each group are displayed on the subscriber's mobile device. Additionally, various members of each group may be displayed by icons having different colors or shapes to identify the group they belong.

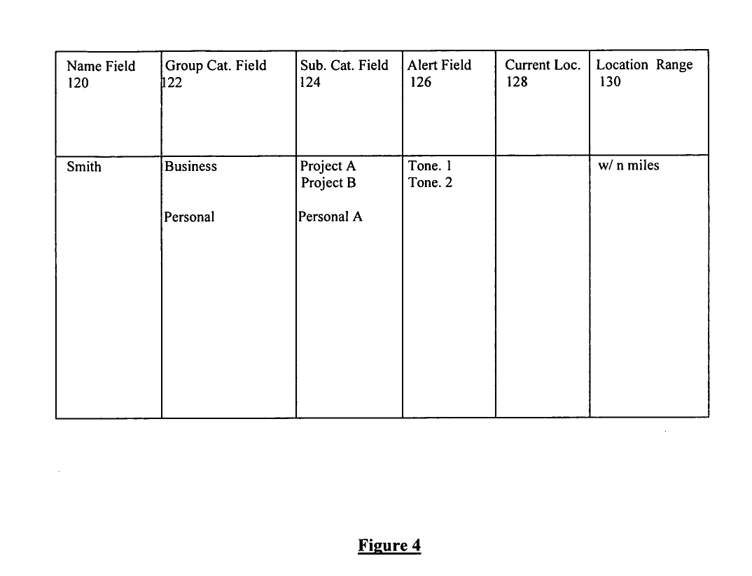

Group database 66 stores updated information records for each group member. FIG. 4 illustrates an exemplary file record 110 having a name field 120, a group category field 122, a group sub category field 124, an alert field 126, a current location field 128, and a location range field 130. To this end, as the subscriber interacts with group categorization module 64, the information contained in group database 110 is stored accordingly. Name field 120 contains the identification information for a member within a group. Group categories field 122 assigns the category to each member, such as for example, whether the member is a business contact or personal contact.

Sub category field 124 further defines the category identified by group category field 122. For example, within a personal category, a sub category field can be defined for individual friends within a dormitory, or a book club, or team members in a sports team, or classmates or any other groups with common interests and friendships.

Alerts field 126 allows the mobile device subscriber to assign the type of alert that the system generates when an individual is within a predetermined distance. For example, one option for such alerts could be the ring tone generated when another group member is close by. Another option may include a text alert and/or email to a pre defined location.

Current location field 128 contains the geographic location of the individual group member, which is received from directory assistance system 10 and is continuously updated.

Location range field 130 contains the geographical range within which an alert is warranted. The subscriber can set a desired range, so as to trigger an alert when a group member is located within the specified geographical range.

Referring back to FIG. 2, mobile interface and processing module 60 is also coupled to a profile update module 68. Profile update module 68 interacts with the subscribers to obtain demographic information, along with their preferences for goods and services. This information allows businesses to send targeted advertising to mobile phone devices that are within a specified proximity to their business establishments.

Mobile interface and processing module 60 is also coupled to a coupon and promotion module 70, which is configured to receive various promotions sent by businesses when the location of mobile device falls within the territory of their targeted advertising. The coupon and promotion module allows the mobile device subscriber to redeem the promotion when they decide to purchase the advertised goods or service.

Finally, a query builder module 62 is coupled to mobile interface and processing system 60, and is configured to compile formatted queries based on a subscriber's request. For example, a query is formatted when a subscriber requests the location of all group members within a specified group (buddy) list. Additionally a query can also be formatted when the subscriber requests the nearest business within a specified category.

It is noted that although in accordance with one embodiment of the invention, the modules described in reference with FIGS. 2 and 3 reside within a mobile device, other embodiments of the invention include an arrangement that the functionality and modules so described reside within the directory assistance system 10.

The operation of directory assistance system 10 for setting up targeted business advertising is explained in more detail in accordance with various embodiments of the invention. There are many occasions that goods and service providers desire to distribute targeted advertising to people who are in the vicinity of their businesses. Currently, such businesses employ the costly arrangement of printing flyers and brochures and hiring personnel to stand at street intersections or shopping malls to distribute targeted promotions and advertising.

In accordance with one embodiment of the present invention, system 10 allows a business establishment to dynamically prepare electronic flyers and distribute them to a targeted group of potential customers who are located within pre specified proximity of the business at any desired time during the day. To this end, FIG. 5 illustrates a flow chart for setting up such a dynamic advertising campaign. Accordingly at step 410, a business owner contact directory assistance 10. This contact may be established via Internet, or via a phone or fax call to a directory assistance representative.

At step 412, after an interaction with system 10, the advertising content, along with any promotional material, such as an electronic coupon, or a promotion code password is transmitted to directory assistance 10. Advertising registration module 38 is configured to process the interaction with the advertiser, including processing the billing, and establishing coupon or promotion code tracking.

At step 414, advertising registration module 38, provides options for setting up a target to which the advertising content is going to be distributed. Some of the options include the range of mobile devices within which will receive the targeted advertising. To this end, the business owner can specify the distance of potential customers to the business location that will receive the advertising content along with any promotions. Other options may include the demographics of the targeted consumers as obtained from subscriber database 34. Such demographics may include age, gender, goods and services that have been identified by the subscribers as their preferences, the time of the day and any other attribute that can assist the advertiser in defining a more relevant target.

To this end, directory assistance system 10 may establish a bidding process, if more than one specific business category intends to distribute advertising content to same geographic location. The bidding process may include the arrangement of ranking the order of advertising content sent to the mobile devices or an arrangement for using allotted times on an exclusive basis.

Once the advertiser is approved by system 10, at step 416 the list of mobile devices that match the target criteria is identified within subscriber database 34. Directory assistance system 10, thereafter transmits the advertising content to the identified mobile devices at step 418. In accordance with various embodiments of the invention, the transmission to each mobile device is tailored to the preferences of the mobile device subscriber, and can be in the form of SMS, email, Text Messaging, Voice Mail or a pop up window on a web page.

As mentioned earlier, in accordance with various embodiments of the invention, all mobile device subscribers can be reached, regardless of the mobile service provider that handles their mobile communication services. As an incentive to the mobile service provider to get consent from its subscribers to allow directory assistance system to have access to their locations for advertising purposes, the billing arrangement may include providing a payment structure to the mobile service provider every time and advertisement campaign is launched.

At step 419 directory assistance system 10 begins tracking the promotions broadcasted to the targeted mobile devices, including the steps of tracking the transmitted coupons or promotion codes, their expiration and whether they are redeemed by the targeted customers. Based on the outcome of the advertising campaign at step 416, directory assistance system finalizes the billing as provided by billing module 36.

The arrangement described above in connection with targeted advertising provides limitless opportunities for targeted advertising. Restaurants and clubs can gauge their attendance and launch immediate campaigns when the customers attending their establishments are lower than expected. Specialty stores, such as sports shops, boutiques, hobby and craft shops, can send advertising to those who have already indicated a desire to purchase their goods and services, and need a reminder that they are now within a close proximity to their desired good and service. Political campaigns can send targeted messages to subscribers within a close proximity to a voting station reminding them that they need to cast their vote if they have not done so already.

In another embodiment of the present invention, directory assistance system 10 includes a plurality of virtual data-hosting servers 44, each of which associated with one or more platform clients 50 for storing the data necessary to respond to the subscriber request. For example, in a location service, the data hosting server coupled to the platform server is able to provide to the platform server a number of search request responses or listings that represent the nearest locations and contact information of stores or business that meet the subscriber's requests. Examples of Common Short Codes used for “Nearest to Me”™ (N2M)™ directory assistance are; 1. Pizza=N2M™ Service−PZA01; 2. Starbucks=N2M™ Service−SBX10; and 3. Directory Assistance=N2M™ Service−DA411.

The virtual data hosting server employs scalable and distributed technologies to provide a mechanism to subscribers as if all the data is hosted by the data-hosting server. Such a system and method provided by the present invention is able to overcome the drawbacks associated with the prior art because it allows a subscriber operating a information accessing device such as their mobile telephone or other such device to access only one location for all the requested data.

For example, if a subscriber requests the five nearest fast food restaurants, the subscriber will enter the search on their client device such as cellular telephone. If the information is already stored in their device, possibly from a prior similar search the results will be displayed to the subscriber. If however, there is not enough data in the client device to list five closest fast food restaurants, then the client device further transmits the request to the directory assistance system. Here a directory assistance agent (or automated response platform) handles the verbal or text request to find the nearest five fast food restaurants to the subscriber of the client device. Here the platform server will search its data hosting server for listings that meet the subscriber's criteria. If it can produce all of the results then they are forwarded to the subscriber's client device for display. If not, then the virtual data hosting server will further perform a data search of other remotely located data hosting servers (such as an internet search) to further supplement the results. In the end the subscriber of the client device enters a single search on their device and receives a single response that meets their criteria. However, because the search is done seamlessly, the client is unaware of whether the data came from the client device, the data hosting server of the platform server or from a virtual data hosting server which obtained the information from a remotely located data server. This eliminates the need for a subscriber to perform numerous searches through different databases, by providing a single multi-layer seamless search platform.

This is particularly advantageous because for handheld client devices, it is very inconvenient for the subscriber to access data from different locations, or to try to integrate data from different sources. The present invention thus provides for a wireless data delivery system serving a plurality of types of wireless devices and a plurality of application servers. The method of virtual data hosting uses a plurality of data hosting servers. Here the data hosting servers accept data access requests from client devices. The requests are distributed to a suitable data hosting server for processing. This data hosting server processes the request, and delivers the requested data to the requesting client device. In the present invention, the data hosting server preferably has the same configuration as the application servers to increase the seamless effect to the subscriber. The distribution of the requests by the virtual data hosting server is preferably performed with data hosting servers scattered across different geographical locations and is performed by a load balancing arrangement.

As mentioned before in reference with FIGS. 2 and 3, another embodiment of the present invention is the arrangement for enabling location services with social group or friend lists so that in addition to performing the above described nearest to me functions regarding closest business etc . . . , the system of the present invention may also provide location data on other individuals within the group.

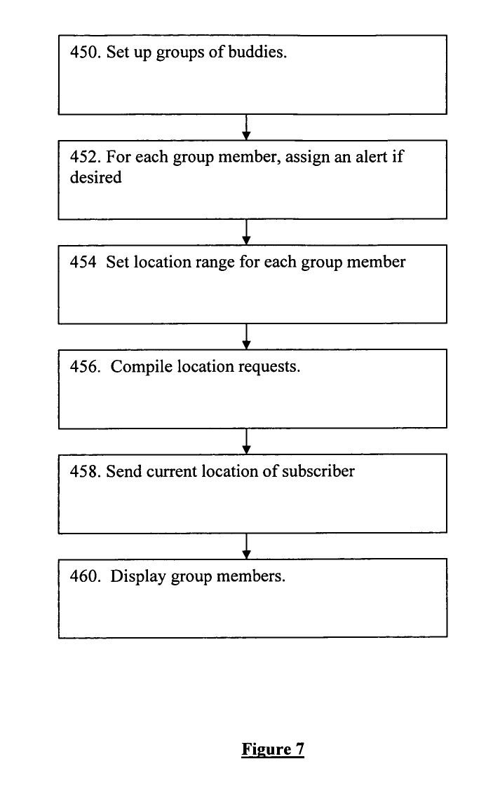

FIG. 7 illustrates a flow chart illustrating some aspects of subscribers operating their mobile devices in accordance with various embodiments of the invention. For example, at step 450 a subscriber interacts with client platform 50 to set up one or more groups of individuals within their social network. To this end, group categorization module 64, interacts with the subscriber so as to allow the subscriber to define a group and sub group category and assign each person listed in their directory to one or more groups and sub groups.

At step 452, for each of the group members, the subscriber has the choice to assign an alert mechanism, so that when the group member is within a certain proximity to the subscriber. The subscriber can set a desired alert mode, such as a specific ring tone for a corresponding group member. Additionally, the subscriber can also set requests for sending an alert message to a predefined destination, such as an email address. Other alert modes include SMS or Text Messaging, or voice calls to a designated phone number.

At step 454, the subscriber sets location ranges for each group member, within which an alert is necessary. The location ranges can be modified as desired by the subscriber.

Once the group members and their categories and sub categories are defined, client platform 50 employs query builder 62 to compile location requests of each group member at step 456. At the same time, the subscriber's current location and azimuth information is processed and sent to directory assistance system 10 at step 458, either directly or via mobile service provider 12.

As such the subscriber is enabled to view the location of various group members in each group at step 460. Client platform 50 displays members of each group category or sub category either separately or in combination. To enhance the visual effect, client platform 50 may employ different color schemes and/or icons for each group or subgroup, when more than one category or sub category is displayed on the same map.

The functionality of locating other group members is employed in combination with other directory assistance services in accordance with another embodiment of the invention. For example, a subscriber may use the nearest to me functions as described in detail above such as requesting the location of the nearest Chinese restaurant(s). However, rather than simply providing the restaurant locations, the return information may also include ratings of the restaurants that are generated by other members of the social group to which the subscriber belongs. This ensures that ratings are provided by members of a similar peer group. If the subscriber attends the requested location, they may be prompted by the system to submit a review of that location.

Another feature of the present invention, in addition to providing results to the nearest to me request is to provide dynamic updates based on the location of the subscriber. For example, if a subscriber is located within a city and requests a nearest to me search for a Chinese restaurant, the system will provide the nearest location or locations. However, as the subscriber walks or drives towards the site, the system may continuously or periodically update the subscriber's location and provide additional responses that the subscriber passes by, such as advertisers on the system who may be having a promotion. Thus, if the subscriber passes by a movie theatre or a clothing store for example, on the way to restaurant, the system may send a dynamic update message to the subscriber telling them that they are passing by or are within the vicinity of a movie theatre or clothing store that is having a promotion and possibly may display additional corresponding information. A link may be included to contact the theatre, allow ticket purchasing or obtain a discount coupon.

Yet another service provided by the present invention would be to provide location information to the subscriber for other members of the social group that are located near the requested destination. For example, in the above illustration, a subscriber requested the location of the nearest Chinese restaurant. However, in addition to the restaurant location, the system may also provide the physical location of other members of the social group that are at the restaurant or in the nearby area. This allows the subscriber to contact them to determine if they would like to join with the subscriber. This feature may also be dynamically updated as the subscriber moves towards the location if they should pass by other members of the social group, or if other members of the group are on the move.

It is understood that the subscriber may simply request a nearest to me search for other members of the social group. This is simply a location of other members of the social group in the nearby area. If they are in a particular location, such as a restaurant or club, that information may also be provided as well.

Such features may be employed with security features that allow members of the group to either open or mask their location as desired.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

We claim:

1. A method for sending a targeted advertising campaign to a plurality of mobile phone devices, said method comprising the steps of:
(a) receiving geographic information relating to geographic location of mobile phone devices said information collected from a plurality of corresponding mobile service providers;
(b) maintaining a subscriber database that contains contact information relating to a plurality of subscribers;
(c) interacting with an advertiser so as to receive advertising content intended for targeted mobile phone devices; and
(d) communicating said advertising content to said targeted mobile phone devices that are located within a specified distance from a location specified by said advertiser.

2. A method in accordance with claim 1, said maintaining step further comprises the step of maintaining demographic information relating to each of said subscribers.

3. A method in accordance with claim 1, wherein said maintaining step further comprises the step of maintaining preferences for goods and services of each of said subscribers.

4. The method in accordance with claim 3, further comprising the step of generating an advertising promotion code and communicating said advertising promotion code to said targeted mobile phone devices.

5. The method in accordance with claim 4, wherein said advertising promotion code further comprises an advertising electronic coupon.

6. The method in accordance with claim 4, wherein said advertising promotion code further comprises a promotion password.

7. The method in accordance with claim 4 further comprising the step of tracking said advertising promotion code for redemption by a consumer.

8. The method in accordance with claim 1, wherein said communicating step further comprises the step of communicating to said targeted mobile devices via at least one of arrangements including SMS, Text messaging, email, voice mail, and pop up window on a web page.

9. The method in accordance with claim 1 further comprising a payment arrangement to each one of said mobile service providers for providing location information of mobile devices of their corresponding subscribers.

10. The method in accordance with claim 1 further comprising the step of providing financial incentives to those subscribers who are willing to receive said advertising content.

11. The method in accordance with claim 10 wherein said financial incentives include free directory assistance services.

12. A method for providing location information of a plurality of mobile devices, said method comprising the steps of:
receiving geographic information relating to geographic location of said mobile phone devices said information being collected from a plurality of corresponding mobile service providers;
receiving a request from a subscriber mobile device to track a geographic location of another mobile device as identified by said subscriber;
retrieving said geographic location of another mobile device; and
communicating said geographic location of said another mobile device to said subscriber mobile device.

13. The method in accordance with claim 12, further comprising a step of receiving request from said subscriber mobile device to track geographic locations of a group of other mobile devices identified by a requester of said request.

14. The method in accordance with claim 13 wherein said group comprises categories and sub categories.

15. The method in accordance with claim 14 wherein said communicating step further comprises the step of providing instructions to said subscriber mobile device to display locations of a desired set of mobile devices of said group on a map.

16. The method in accordance with claim 15 wherein each mobile device relating to each category is displayed by a distinguishing identifier such as color and icon.

17. The method in accordance with claim 12 further comprising the step of providing an alert to said subscriber mobile device when a desired one of said another mobile device is locating within a specified distance from said subscriber mobile device.

18. The method in accordance with claim 17 wherein said subscriber mobile device is provided with a directory assistance service for locating a business category nearest to said mobile device.

19. The method in accordance with claim 18 further comprising the step of said subscriber mobile device sending invitation to a plurality of other mobile devices that are located within a specified distance from said located business.

20. A system for gathering and updating location information of a plurality of mobile devices said system comprising:
a plurality of mobile devices each of which communication via a corresponding mobile service provider;
a carrier location gateway coupled to each of said mobile service providers for receiving geographic information of each of said mobile devices via their corresponding mobile service provider; and
a directory assistance platform coupled to said carrier location gateway for retrieving said geographic locations of said mobile devices corresponding to each one of said mobile service providers.

21. The system in accordance with claim 20 wherein said geographic information further comprises GPS information received from each of said mobile devices.

22. The system in accordance with claim 21 wherein said geographic information further includes azimuth information received from each of said mobile devices.

23. The system in accordance with claim 20 wherein said directory assistance platform is configured to receive advertising content from an advertising source, so as to communicate said advertising content to a group of mobile devices whose location is updated by said directory assistance system.

24. The system in accordance with claim 23, wherein said mobile devices are those that are located within a specified distance from a desired location.

25. The system in accordance with claim 20 wherein said directory assistance system comprises:
a subscriber database configured to store subscriber information for each mobile phone device subscribed with the system;
a location update module configured to retrieve location information of each of said mobile phone devices; and
an advertising module configured to interface with said advertising source so as to receive advertising content for a desired advertising campaign intended for a targeted group of mobile devices.

26. The system in accordance with claim 25 further comprising a registration module configured to contact a specified set of mobile devices so as to subscribe said mobile devices with said directory assistance system.

27. The system in accordance with claim 26, further comprising a billing module to track payments to said mobile service providers for obtaining said geographic locations.

28. The system in accordance with claim 20, wherein said mobile phone devices include a client platform comprising a location update module so as to obtain the location of said mobile device.

29. The system in accordance with claim 28 further comprising a GPS system and an azimuth information system so as to provide the location and height of said mobile device.

30. The system in accordance with claim 29 wherein said azimuth information is provided so as to identify the floor location of said mobile device in a multi story building.

31. The system in accordance with claim 28 wherein said mobile device further comprises:
a group categorization module so as to assign a group category to a contact listing maintained in said mobile device; and
a group database configured to store the location of mobile phone devices identified by said group categorization module.

32. The system in accordance with claim 31 further comprising an alert module so as to set up an alert when any one of said mobile devices within a group category are within a specified distance from said mobile device.
